(19) United States
(12) Patent Application Publication
(10) Pub. No.: US 2024/0163480 A1
(43) Pub. Date: May 16, 2024

(54) METHOD AND APPARATUS OF ENCODING/DECODING POINT CLOUD CAPTURED BY A SPINNING SENSORS HEAD

(71) Applicant: BEIJING XIAOMI MOBILE SOFTWARE CO., LTD., Beijing (CN)

(72) Inventors: Sebastien LASSERRE, Beijing (CN); Jonathan TAQUET, Beijing (CN)

(73) Assignee: BEIJING XIAOMI MOBILE SOFTWARE CO., LTD., Beijing (CN)

(21) Appl. No.: 18/575,807

(22) PCT Filed: Apr. 20, 2022
(86) PCT No.: PCT/CN2022/088037

§ 371 Date: Dec. 29, 2023

(30) Foreign Application Priority Data
Jul. 2, 2021 (EP) 21305921.5

(51) Int. Cl. H04N 19/597; H04N 19/91

(52) U.S. Cl. CPC H04N 19/597; H04N 19/91

(57) ABSTRACT

There is provided methods and apparatus of encoding/decoding a point cloud captured by a set of sensors. The encoding method obtains a list of ordered points of the point cloud by ordering the points according to a lexicographic order based on azimuthal angles and sensor indices associated with points of the point cloud; obtains a next point following a current point in the list of ordered points and having an order index different of an order index of the current point, and obtains a number of duplicated points equals to a number of points following the current point that have an order index equals to the order index of the current point; encodes the number of duplicated points and encodes an order index difference representing a difference between the order index of the next point and the order index of the current point.

### CROSS-REFERENCE TO RELATED APPLICATION

This application is the U.S. national phase application of International Application No.: PCT/CN2022/088037, filed on Apr. 20, 2022, which claims priority to EP application No.: 21305921.5, filed on Jul. 2, 2021, the entire disclosures of which are incorporated herein by reference for all purposes.

### BACKGROUND

The present section is intended to introduce the reader to various aspects of art, which may be related to various aspects of at least one exemplary embodiment of the present application that is described and/or claimed below. This discussion is believed to be helpful in providing the reader with background information to facilitate a better understanding of the various aspects of the present application.

As a format for the representation of 3D data, point clouds have recently gained traction as they are versatile in their capability in representing all types of physical objects or scenes. Point clouds may be used for various purposes such as culture heritage/buildings in which objects like statues or buildings are scanned in 3D in order to share the spatial configuration of the object without sending or visiting it. Also, it is a way to ensure preserving the knowledge of the object in case it may be destroyed; for instance, a temple by an earthquake. Such point clouds are typically static, colored and huge.

Another use case is in topography and cartography in which using 3D representations allows for maps that are not limited to the plane and may include the relief. Google Maps is now a good example of 3D maps but uses meshes instead of point clouds. Nevertheless, point clouds may be a suitable data format for 3D maps and such point clouds are typically static, colored and huge.

Virtual Reality (VR), Augmented Reality (AR) and immersive worlds have recently become a hot topic and are foreseen by many as the future of 2D flat video. The basic idea is to immerse the viewer in a surrounding environment, in contrast to a standard TV that only allows the viewer to look at the virtual world in front of him/her. There are several gradations in the immersivity depending on the freedom of the viewer in the environment. A point cloud is a good format candidate for distributing VR/AR worlds.

The automotive industry, and more particularly foreseen autonomous cars, are also domains in which point clouds may be intensively used. Autonomous cars should be able to “probe” their environment to make good driving decisions based on the detected presence and nature of their immediate nearby objects and road configuration.

A point cloud is a set of points located in a tridimensional (3D) space, optionally with additional values attached to each of the points. These additional values are usually called attributes. Attributes may be, for example, three-component colors, material properties like reflectance and/or two-component normal vectors to a surface associated with a point.

A point cloud is thus a combination of a geometry (locations of the points in a 3D space usually represented by 3D cartesian coordinates x, y and z) and attributes.

Point clouds may be captured by various types of devices like an array of cameras, depth sensors, lasers (light detection and ranging, also known as Lidars), radars, or may be computer-generated (for example in movie post-production). Depending on the use cases, points clouds may have from thousands to up to billions of points for cartography applications. Raw representations of point clouds require a very high number of bits per point, with at least a dozen of bits per cartesian coordinate x, y or z, and optionally more bits for the attribute(s), for instance three times 10 bits for the colors.

It is important in many applications to be able to either distribute point clouds to an end-user or store them in a server by consuming only a reasonable amount of bitrate or storage space, while maintaining an acceptable (or preferably very good) quality of experience. Efficient compression of these point clouds is a key point in order to make the distribution chain of many immersive worlds practical.

Compression may be lossy (like in video compression) for the distribution to and visualization by an end-user, for example on AR/VR glasses or any other 3D-capable device. Other use cases do require lossless compression, like medical applications or autonomous driving, to avoid altering the results of a decision obtained from the subsequent analysis of the compressed and transmitted point cloud.

Until recently, point cloud compression (aka PCC) was not addressed by the mass market and no standardized point cloud codec was available. In 2017, the standardization working group ISO/JCT1/SC29/WG11, also known as Moving Picture Experts Group or MPEG, has initiated work items on point cloud compression. This has led to two standards, namely
MPEG-I part 5 (ISO/IEC 23090-5) or Video-based Point Cloud Compression (V-PCC)
MPEG-I part 9 (ISO/IEC 23090-9) or Geometry-based Point Cloud Compression (G-PCC)

The V-PCC coding method compresses a point cloud by performing multiple projections of a 3D object to obtain 2D patches that are packed into an image (or a video when dealing with dynamic point clouds). Obtained images or videos are then compressed using already existing image/video codecs, allowing for the leverage of already deployed image and video solutions. By its very nature, V-PCC is efficient only on dense and continuous point clouds because image/video codecs are unable to compress non-smooth patches as would be obtained from the projection of, for example, Lidar-captured sparse geometry data.

The G-PCC coding method has two schemes for the compression of a captured sparse geometry data.

The first scheme is based on an occupancy tree, being locally any type of tree among octree, quadtree or binary tree, representing the point cloud geometry. Occupied nodes are split down until a certain size is reached, and occupied leaf nodes provide the 3D locations of points, typically at the center of these nodes. The occupancy information is carried by occupancy flags signaling the occupancy status of each of the child nodes of nodes. By using neighbor-based prediction techniques, high level of compression of the occupancy flags can be obtained for dense point clouds. Sparse point clouds are also addressed by directly coding the position of point within a node with non-minimal size, by stopping the tree construction when only isolated points are present in a node; this technique is known as Direct Coding Mode (DCM).

The second scheme is based on a predictive tree in which each node represents the 3D location of one point and the parent/child relation between nodes represents spatial prediction from parent to children. This method can only address sparse point clouds and offers the advantage of lower latency and simpler decoding than the occupancy tree. However, compression performance is only marginally better, and the encoding is complex, relatively to the first occupancy-based method, because the encoder must intensively look for the best predictor (among a long list of potential predictors) when constructing the predictive tree.

In both schemes, attribute (de)coding is performed after complete geometry (de)coding, leading practically to a two-pass coding. Thus, the joint geometry/attribute low latency is obtained by using slices that decompose the 3D space into sub-volumes that are coded independently, without prediction between the sub-volumes. This may heavily impact the compression performance when many slices are used.

Combining together requirements on encoder and decoder simplicity, on low latency and on compression performance is still a problem that has not been satisfactory solved by existing point cloud codecs.

An important use case is the transmission of sparse geometry data captured by a spinning sensors (lidar) head mounted on a moving vehicle. This usually requires a simple and low latency embarked encoder. Simplicity is required because the encoder is likely to be deployed on computing units which perform other processing in parallel, such as (semi-)autonomous driving, thus limiting the processing power available to the point cloud encoder. Low latency is also required to allow for fast transmission from the car to a cloud in order to have a real-time view of the local traffic, based on multiple-vehicle acquisition, and take adequate fast decision based on the traffic information. While transmission latency can be low enough by using 5G, the encoder itself shall not introduce too much latency due to coding. Also, compression performance is extremely important since the flow of data from millions of cars to the cloud is expected to be extremely heavy.

Specific priors related to spinning sensors-captured sparse geometry data have been already exploited in G-PCC and have led to very significant gains of compression.

First, G-PCC exploits the elevation angle (relative to the horizontal ground) of capture from a spinning sensors head as depicted on FIGS. 1 and 2. A spinning sensors head 10 comprises a set of sensors 11, here five sensors are represented. The spinning sensors head 10 may spin around a vertical axis z to capture geometry data of a physical object. Sensors-captured geometry data is then represented in spherical coordinates (r_{3D}, ϕ, θ), where r_{3D} is the distance of a point Pₙ from the spinning sensors head's center, ϕ is an azimuthal angle of the spinning sensors head's spin relative to a referential (for example the longitudinal axis of the spinning sensors head), and θ is an elevation angle of a sensor k of the spinning sensors head relative to a horizontal referential plane (for example a plane perpendicular to the axis z).

A regular distribution along the azimuthal angle has been observed on spinning sensors captured data as depicted on FIG. 3. This regularity is used in G-PCC to obtain a quasi 1D representation of the point cloud where, up to noise, only a radius r_{3D} belongs to a continuous range of values while the angles ϕ and θ take only a discrete number of values ϕᵢ∀i=0 to I−1 where I is a number of azimuthal angles used for the capture of the points and θₖ∀k=0 to K−1 where K is a number of sensors of the spinning sensors head 10. Basically, G-PCC represents spinning sensors-captured sparse geometry data on a 2D discrete angular plane (ϕ, θ) as depicted on FIG. 3, together with a radius value r_{3D} for each point.

This quasi 1D property has been exploited in G-PCC in both the occupancy tree and the predictive tree by predicting, in the spherical coordinates space, the location of a current point based on an already coded point by using the discrete nature of angles.

More precisely, the occupancy tree uses DCM intensively and entropy codes the direct locations of points within a node by using a context-adaptive entropy coder. Contexts are then obtained from the local conversion of the point locations into angular coordinates (ϕ, θ) and from the location of these angular coordinates relative to discrete angular coordinates (ϕᵢ, θₖ) obtained from precedingly coded points. The predictive tree directly codes a first version of a point location in the spherical coordinates (r_{2D}, ϕ, θ), where r_{2D} is the projected radius on the horizontal xy plane as depicted on FIG. 4, using the quasi 1D nature (r_{2D}, ϕᵢ, θₖ) of this coordinate space. Then, spherical coordinates (r_{2D}, ϕ, θ) are converted into 3D cartesian coordinates (x, y, z) and a xyz residual is coded to tackle the errors of coordinate conversion, the approximation of elevation and azimuthal angles and potential noise.

G-PCC does use the angular priors to better compress spinning sensors-captured sparse geometry data but does not adapt the coding structure to the order of capture. By its very nature, the occupancy tree must be coded down to its last depth before outputting a point. This occupancy is coded in the so-called breadth-first order: the occupancy of the root node is first coded, indicating its occupied child nodes; then the occupancy for each of the occupied child nodes is coded, indicating the occupied grand-child nodes; and so on iteratively over the tree depth until leaf nodes can be determined and the corresponding points are provided/output to an application or to the attribute(s) coding scheme. Regarding the predictive tree, the encoder is free to choose the order of point in the tree, but to obtain good compression performance, to optimize the prediction accuracy, G-PCC proposes to code one tree per sensor, as depicted on FIG. 5. This has mainly the same drawback as using one coding slice per sensor, i.e. non-optimal compression performance because prediction between sensors is not allowed and does not provide encoder low latency. Worse, one should have one coding processing per sensor and the number of core coding units should equal the number of sensing sensors; this is not practical.

In brief, in a framework of a spinning sensors head used for capturing sparse geometry data of a point cloud, prior arts do not solve the problem of combining encoding and decoding simplicity, low latency and compression performance.

### SUMMARY

The following section presents a simplified summary of at least one exemplary embodiment in order to provide a basic understanding of some aspects of the present application. This summary is not an extensive overview of an exemplary embodiment. It is not intended to identify key or critical elements of an embodiment. The following summary merely presents some aspects of at least one of the exemplary embodiments in a simplified form as a prelude to the more detailed description provided elsewhere in the document. The present application generally relates to methods and apparatus of encoding/decoding point cloud captured by a spinning sensors head.

According to a first aspect of the present application, there is provided a method of encoding a point cloud captured by a set of sensors into a bitstream of encoded point cloud data. The method comprises a) obtaining, for a point of the point cloud, a sensor index associated with a sensor that captured the point, an azimuthal angle representing a capture angle of said sensor, each captured point being represented by a point in a 2D discrete angular plane in which said sensor index is a coordinate of a first axis of the 2D discrete angular plane and said azimuthal angle is a coordinate of a second axis of the 2D discrete angular plane; b) obtaining a list of ordered points of the point cloud by ordering the points according to a lexicographic order based first on the azimuthal angles and then on the sensor indices or inversely, an order index being associated with each point of the point cloud according to the rank of said point in the list of ordered points; c) obtaining a next point following a current point in the list of ordered points, and having an order index different of an order index of the current point, and obtaining a number of duplicated points, which equals to a number of points following the current point that have an order index equals to the order index of the current point; d) encoding, in the bitstream, the number of duplicated points; e) obtaining and encoding, in the bitstream, an order index difference representing a difference between the order index of the next point and the order index of the current point; f) updating the current point by considering the next point as being a new current point; and the steps c), d), e) and f) are iterated until all the points of the list of ordered points have been considered.

In one exemplary embodiment, encoding the number of duplicated points comprises: binarizing the number of duplicated points into a series of binary data whose number is lower than or equal to a maximum bound; and entropy coding each binary data of the series of binary data.

According to a second aspect of the present application, there is provided a method of decoding a point cloud captured by a set of sensors from a bitstream of encoded point cloud data. The method comprises a) decoding, from the bitstream, an information representative of a number of duplicated points associated with an already decoded current point of the point cloud; b) reconstructing a number of duplicated points, which equals to the decoded number of duplicated points, each duplicated point having a same azimuthal angle equaling to an azimuthal angle of said already decoded current point, and a sensor index equaling to a sensor index of said already decoded current point; c) decoding an order index difference from the bitstream for a next point, said next point having an order index different of an order index of the already decoded current point, an order index being associated with a point of the point cloud according to a rank of said point in a list of ordered points obtained by ordering the points of the point cloud according to a lexicographic order based first on azimuthal angles and then on sensor indices associated with the points of the point cloud, or inversely; d) obtaining an order index for the next point from the decoded order index difference and the order index of the already decoded current point; e) obtaining a sensor index associated with a sensor that captured the next point and an azimuthal angle representing a capture angle of said sensor from the order index of the next point ; the already decoded current is updated by considering the next point as being a new already decoded current point and iterating steps a) to e), until all the information representative of a number associated with an already decoded current point of the point cloud are decoded.

According to a third aspect of the present application, there is provided an apparatus of encoding a point cloud captured by a set of sensors into a bitstream of encoded point cloud data. The apparatus comprises one or more processors configured to carry out a method according to the first aspect of the present application.

According to a fourth aspect of the present application, there is provided an apparatus of decoding a point cloud captured by a set of sensors from a bitstream of encoded point cloud data. The apparatus comprises one or more processors configured to carry out a method according to the second aspect of the present application.

According to a fifth aspect of the present application, there is provided a bitstream of encoded point cloud data captured by a set of sensors, wherein the bitstream comprises at least one syntax element carrying at least one information representative of a number of duplicated points associated with a decoded current point of the point cloud.

According to a sixth aspect of the present application, there is provided a computer program product including instructions which, when the program is executed by one or more processors, causes the one or more processors to carry out a method according to the first aspect of the present application.

According to a seventh aspect of the present application, there is provided a non-transitory storage medium carrying instructions of program code for executing a method according to the first aspect of the present application.

According to an eighth aspect of the present application, there is provided a computer program product including instructions which, when the program is executed by one or more processors, causes the one or more processors to carry out a method according to the second aspect of the present application.

According to a ninth aspect of the present application, there is provided a non-transitory storage medium carrying instructions of program code for executing a method according to the second aspect of the present application.

The specific nature of at least one of the exemplary embodiments as well as other objects, advantages, features and uses of said at least one of exemplary embodiments will become evident from the following description of examples taken in conjunction with the accompanying drawings.

### BRIEF DESCRIPTION OF THE DRAWINGS

Reference will now be made, by way of example, to the accompanying drawings which show exemplary embodiments of the present application, and in which:

FIG. 1 illustrates a side view of a sensors head and some of its parameters in accordance with prior art;

FIG. 2 illustrates a top view of the sensors head and some of its parameters in accordance with prior art;

FIG. 3 illustrates a regular distribution of data captured by a spinning sensors head in accordance with prior art;

FIG. 4 illustrates a representation of a point in a 3D space in accordance with prior art;

FIG. 5 illustrates the encoding of a predictive tree in accordance with prior art;

FIG. 6 illustrates a block diagram of steps of a method 100 of encoding a point cloud into a bitstream of encoded point cloud data in accordance with at least one exemplary embodiment of the present disclosure;

FIG. 7 illustrates an example of ordered captured point represented in a 2D space in accordance with one exemplary embodiment of the present disclosure;

FIG. 8 illustrates another example of ordered captured point represented in a 2D space in accordance with one exemplary embodiment of the present disclosure;

FIG. 9 illustrates an example of captured points in accordance with one exemplary embodiment of the present disclosure;

FIG. 10 illustrates an example of ordered and quantized captured points in accordance with one exemplary embodiment of the present disclosure;

FIG. 11 illustrates a block diagram of steps of a method 200 of decoding a point cloud from a bitstream of encoded point cloud data in accordance with at least one exemplary embodiment of the present disclosure;

FIG. 12 illustrates a block diagram of steps of a method 300 of entropy-coding a number of duplicated points in accordance with at least one exemplary embodiment of the present disclosure;

FIG. 13 illustrates a block diagram of steps of a method 400 of entropy-coding an order index difference in accordance with at least one exemplary embodiment of the present disclosure;

FIG. 14 illustrates a block diagram of a context-adaptive arithmetic encoders in accordance with at least one exemplary embodiment of the present disclosure;

FIG. 15 shows a block diagram of steps of a method 500 of entropy-decoding a number of duplicated points in accordance with at least one exemplary embodiment of the present disclosure;

FIG. 16 shows a block diagram of steps of a method 600 of entropy-decoding an order index difference in accordance with at least one exemplary embodiment of the present disclosure; and

FIG. 17 illustrates a schematic block diagram of an example of a system in which various aspects and exemplary embodiments are implemented in accordance with at least one exemplary embodiment of the present disclosure.

Similar reference numerals may have been used in different figures to denote similar components.

### DESCRIPTION OF EXEMPLARY EMBODIMENTS

At least one of the exemplary embodiments is described more fully hereinafter with reference to the accompanying figures, in which examples of at least one of the exemplary embodiments are illustrated. An exemplary embodiment may, however, be embodied in many alternate forms and should not be construed as limited to the examples set forth herein. Accordingly, there is no intent to limit exemplary embodiments to the particular forms disclosed. On the contrary, the disclosure is intended to cover all modifications, and alternatives falling within the spirit and scope of the present application.

When a figure is presented as a flow diagram, it also provides a block diagram of a corresponding apparatus. Similarly, when a figure is presented as a block diagram, it also provides a flow diagram of a corresponding method/process.

At least one of the aspects generally relates to point cloud encoding and decoding, and at least one other aspect generally relates to transmitting a bitstream generated or encoded.

Moreover, the present aspects are not limited to MPEG standards such as MPEG-I part 5 or part 9 that relate to the Point Cloud Compression, and may be applied, for example, to other standards and recommendations, whether pre-existing or future-developed, and extensions of any such standards and recommendations (including MPEG-I part 5 and part 9). Unless indicated otherwise, or technically precluded, the aspects described in the present application may be used individually or in combination.

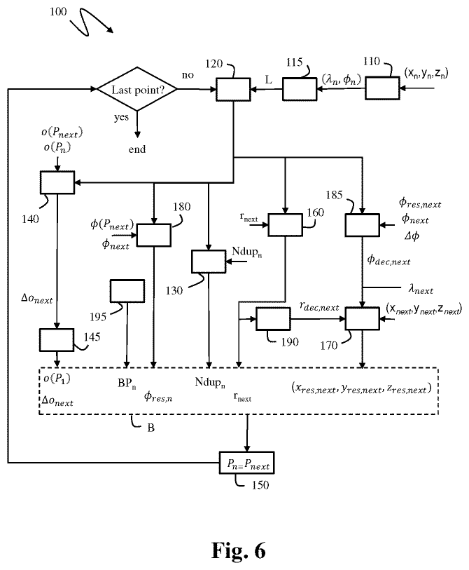

FIG. 6 illustrates a block diagram of steps of a method 100 of encoding a point cloud into a bitstream of encoded point cloud data in accordance with at least one exemplary embodiment.

Geometry data of the point cloud, i.e. the 3D locations of points of the point cloud, is captured by a spinning sensor head.

The spinning sensors head may be the spinning sensors head 10 comprising multiple sensors as explained above. The scope of the disclosure is not limited to a specific sensors and may apply to any spinning sensors head able to spin around an axis and to capture 3D locations points for each capture angular angles. Sensors may be cameras, depth sensors, lasers, Lidars or scanners.

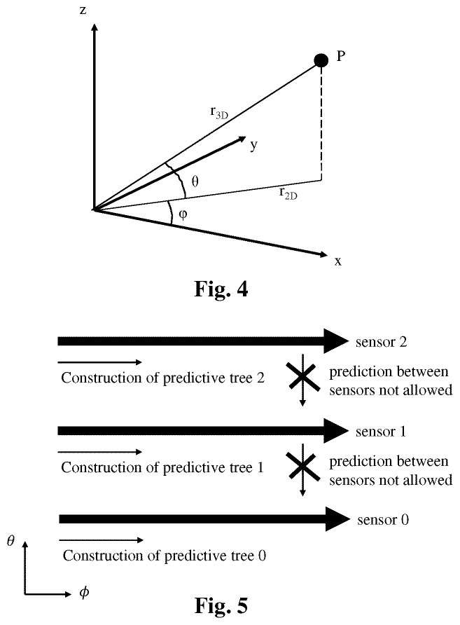

The captured 3D locations are represented in an angular coordinate (ϕ, λ) system, as depicted on FIG. 4, together with radius values r_{2D} or r_{3D}. The coordinate ϕ is the azimuthal angle of the sensor head's spin whose discrete values are denoted ϕᵢ(∀i=0 to I−1). The coordinate λ is a sensor index whose discrete values are denoted λₖ(∀k=0 to K−1). The radius r_{2D} or r_{3D} belongs to a continuous range of values.

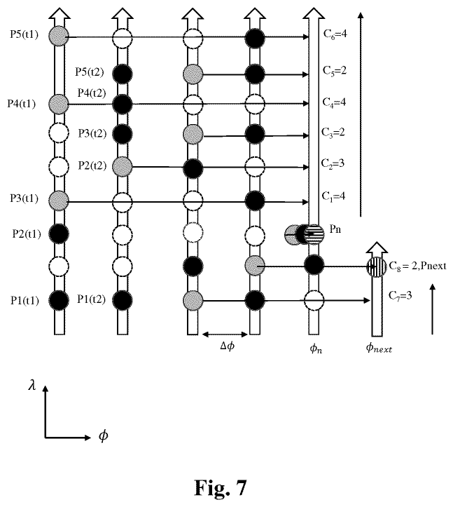

Due to the regular spin (rotation) of the spinning sensors head 10 and the continuous capture with fixed time interval, the azimuthal distance between two points probed by a same sensor is a multiple of an elementary azimuthal shift Δϕ as depicted on FIG. 7. Then, for example, at a first captured time t1, five points P₁(t1), . . . , Pₖ(t1), . . . P₅(t1) are probed by the five sensors of the spinning sensors head 10 of FIG. 1 with an azimuthal angle ϕ₁, at a second capture time t2, five points P₁(t2), . . . , Pₖ(t2), . . . P₅(t2) are probed by the sensors of the spinning sensors head 10 with an azimuth angle ϕ₂=ϕ₁+Δϕ, and so on. Consequently, the discrete value ϕ₁ may be seen as the quantized value of the azimuthal angles ϕ of the points P₁(t1), . . . , Pₖ(t1), . . . P₅(t1); quantization being obtained by a quantization step Δϕ. Similarly, the discrete value ϕ₂ may be seen as the quantized value of the azimuthal angles ϕ of the points P₁(t2), . . . , Pₖ(t2), . . . P₅(t2).

In step 110, for each point Pₙ of the point cloud, a sensor index λₖ₍ₙ₎ (among the set of sensor indices λₖ(∀k=0 to K−1)) associated with a sensor that captured the point Pₙ, an azimuthal angle ϕᵢ₍ₙ₎ (among the set of discrete angles ϕᵢ(∀i=0 to I−1)) representing a capture angle of said sensor and a radius value rₙ of spherical coordinates of the point Pₙ are obtained. For sake of simplicity, λₖ₍ₙ₎ and the index i(n) will be respectively denoted λₙ and ϕₙ hereafter. Consequently, ϕₙ is not an angle but an index i(∀i=0 to I−1)) pointing to an angle ϕᵢ. Nevertheless, because there is an unambiguous relation between the index ϕₙ and the canonically associated azimuthal angle ϕᵢ₍ₙ₎=ϕ_{ϕ}_{ₙ}, the quantity ϕₙ is still referred as an azimuthal angle.

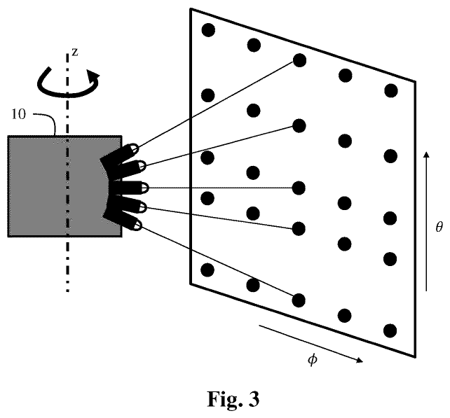

Each captured point Pₙ may be represented by a point in the 2D discrete angular plane illustrated as depicted on FIG. 3, in which the sensor index λₙ is a coordinate of a first axis of the 2D discrete angular plane and the azimuthal angle ϕₙ is a coordinate of a second axis of the 2D discrete angular plane.

In one exemplary embodiment of step 110, the sensor index λₙ and the azimuthal angle ϕₙ are obtained by converting 3D cartesian coordinates (xₙ, yₙ, zₙ) representing the 3D location of a captured point Pₙ. These 3D cartesian coordinates (xₙ, yₙ, zₙ) may be output of the spinning sensors head 10.

In step 115, a list L of ordered points is obtained by ordering (sorting) the points of the point cloud according to a lexicographic order based first on the azimuthal angles ϕₙ and then on the sensor indices λₙ or inversely. An order index is associated with each point Pₙ according to the rank of said point in the list L of ordered points.

In one exemplary embodiment of step 115, the points are ordered (sorted) according to a lexicographic order based first on the azimuthal angle and then on the sensor index. Referring back to FIG. 7, the ordered captured points are P₁(t1), . . . , Pₖ(t1), . . . P₅(t1), P₁(t2), . . . , Pₖ(t2), . . . P₅(t2), . . .

The order index o(Pₙ) of a point Pₙ, i.e. the rank of the point Pₙ in the list L of the ordered points, is obtained by:

o(Pₙ)=ϕₙ*K+λₙ

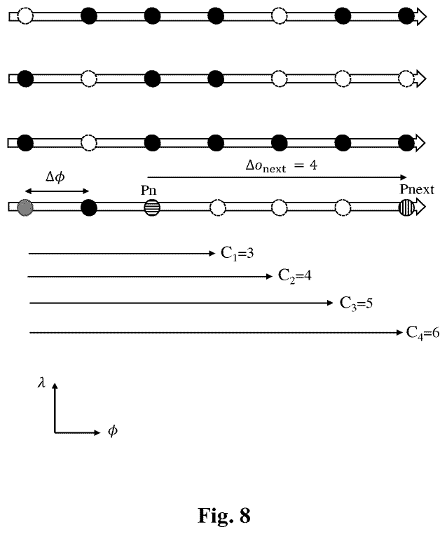

In one exemplary embodiment of step 115, illustrated on FIG. 8, the points are ordered according to a lexicographic order based first on the sensor index and then on the azimuthal angle.

The order index o(Pₙ) of a point Pₙ is obtained by:

o(Pₙ)=λₙ*I+ϕₙ

In step 120, a point Pₙₑₓₜ is obtained for a current point Pₙ of the list L of ordered points. The point Pₙₑₓₜ is a point in the list L of ordered points following the current point Pₙ and having an order index o(Pₙₑₓₜ) different of the order index o(Pₙ) of a current point Pₙ. A number Ndupₙ, associated with the current point Pₙ, is also obtained. The number Ndupₙ equals the number of points following the current point Pₙ that have an order index equals to the order index o(Pₙ) of the current point Pₙ.

Two points have different order indices when they have different sensor indices k(n) and/or different azimuthal angles i(n).

If two ordered points in the list L of ordered points have a same order index, i.e. a same sensor index and a same azimuthal angle, these points are denoted duplicated points. If two ordered points in the list L of ordered points have different sensor indices and/or different azimuthal angles they are denoted non-duplicated points.

The number Ndupₙ equals a number of duplicated points following the current point Pₙ.

In one exemplary embodiment of step 120, starting from the current point Pₙ, a first next point Pₙ₊₁ of the point Pₙ in the list of ordered points is considered. If the point Pₙ₊₁ has an order index equals to the order index o(Pₙ), a two next point Pₙ₊₂ of the current point Pₙ in the list of ordered points is considered. If said two next point Pₙ₊₂ has an order index equals to the order index o(Pₙ), a third next point Pₙ₊₃ of the current point Pₙ in the list L of ordered points is considered, and so on until a next point has an order index different of the order index o(Pₙ). The number Ndupₙ of duplicated points, associated with the current point Pₙ, is incremented each time a next point of the list L of ordered points has an order index equals to the order index o(Pₙ) of the current point.

In step 130, an information representative of the number Ndupₙ, associated with the current point Pₙ, is encoded in the bitstream B.

In step 140, an order index difference Δoₙₑₓₜ is obtained. The order index difference Δoₙₑₓₜ represents a difference between the order index o(Pₙₑₓₜ) and the order index o(Pₙ) of the current point Pₙ:

Δoₙₑₓₜ=o(Pₙₑₓₜ)−o(Pₙ)

By definition of Pₙₑₓₜ being the first point after Pₙ having an order different than o(Pₙ), the value Δoₙₑₓₜ is not equal to zero.

In step 145, the order index difference Δoₙₑₓₜ is encoded in the bitstream B.

The order index o(P₁) of the first point P₁ in the list L of ordered points may be directly coded into the bitstream B. This is equivalent to arbitrary setting the order index of a virtual zero-th point to zero, i.e. o(P₀)=0, and coding Δo₁=o(P₁)−o(P₀)=o(P₁).

Given the order index o(P₁) of the first point and an order difference Δoₙₑₓₜ, the order index o(Pₙₑₓₜ) of a point Pₙₑₓₜ may then be reconstructed by:

o(Pₙₑₓₜ)=o(Pₙ)+Δoₙₑₓₜ

Then, sensor indices λₙₑₓₜ and azimuthal angle ϕₙₑₓₜ are obtained by:

λₙₑₓₜ=o(Pₙₑₓₜ)modulo K (1)

ϕₙₑₓₜ=o(Pₙₑₓₜ)/K (2)
where the division /K is the integer division (aka Euclidian division). Therefore, o(P₁) and Δoₙₑₓₜ are an alternative representation of λₙₑₓₜ and ϕₙₑₓₜ.

In one exemplary embodiment of step 145, the order index difference Δoₙₑₓₜ is entropy-encoded as explained later in reference to FIG. 13.

In step 150, the current point Pₙ is updated by considering the point Pₙₑₓₜ as being the new current point Pₙ.

The steps 120, 130, 140, 145 and 150 iterates until all the points of the list L of ordered points have been considered.

Ordering the captured points provides interaction between points captured by different sensors of the spinning sensors head. A single encoding is thus required for encoding those ordered points leading to a very simple and low latency encoding.

Reconstructing points from the order index differences Δoₙₑₓₜ requires information such as an order index o(P₁) of a first point in the angular coordinates (ϕ, λ) system, and sensor setup parameters such as the elementary azimuthal shift Δϕ or an elevation angle θₖ associated with each sensor. This information may also be encoded in the bitstream B or signaled by another mean or may be known beforehand by a decoder.

In one exemplary embodiment, the method further comprises in step 160, encoding, in the bitstream B, the radius values rₙₑₓₜ of spherical coordinates associated with the point Pₙₑₓₜ.

In one exemplary embodiment of step 160, the radius value rₙₑₓₜ is quantized.

In one exemplary embodiment of step 160, the radius value rₙₑₓₜ is entropy coded.

In one exemplary embodiment of step 160, the radius value rₙₑₓₜ is quantized and entropy coded.

In one exemplary embodiment of step 160, the radius value rₙₑₓₜ represents the radius r_{3D}.

In one exemplary embodiment of step 160, the radius value rₙₑₓₜ represents the projected radius r_{2D} on the horizontal xy plane as depicted on FIG. 4.

In one exemplary embodiment, the method further comprises, in step 170, encoding a residual (x_{res,next}, y_{res,next}, z_{res,next}) of three-dimensional cartesian coordinates of the point Pₙₑₓₜ based on their three-dimensional cartesian coordinates (xₙₑₓₜ, yₙₑₓₜ, zₙₑₓₜ), on a decoded azimuthal angle ϕ_{dec,next}, on a decoded radius value r_{dec,next} obtained from the radius value rₙₑₓₜ, and on a sensor index λₙₑₓₜ.

In one exemplary embodiment of step 170, the residual (x_{res,next}, y_{res,next}, z_{res,next}) is a difference between the three-dimensional cartesian coordinates (xₙₑₓₜ, yₙₑₓₜ, xₙₑₓₜ) of the point Pₙₑₓₜ and estimated three-dimensional coordinates (x_{estim,next}, y_{estim,next}, z_{estim,next}).

In one exemplary embodiment of step 170, the residual (x_{res,next}, y_{res,next}, z_{res,next}) is given by:

$$\{ \begin{matrix}{x}_{res , next} = {x}_{next} - {x}_{estim , next} \\ {y}_{res , next} = {y}_{next} - {y}_{estim , next} \\ {z}_{res , next} = {z}_{next} - {z}_{estim , next}\end{matrix}$$

In one exemplary embodiment of step 170, the estimated coordinates (x_{estim,next}, y_{estim,next}) associated with the point Pₙₑₓₜ are based on decoded the azimuthal angle ϕ_{dec,next} and the decoded radius value r_{dec,next} associated with the point Pₙₑₓₜ.

In one exemplary embodiment of step 170, the residual (x_{res,next}, y_{res,next}, z_{res,next}) is entropy coded.

In one exemplary embodiment of step 170, the estimated coordinates (x_{estim,next}, y_{estim,next}) are given by:

$$\{ \begin{matrix}{x}_{estim , next} = {r}_{dec , next} * cos ( {ϕ}_{dec , next} ) \\ {y}_{estim , next} = {r}_{dec , next} * sin ( {ϕ}_{dec , next} )\end{matrix}$$

In one exemplary embodiment of step 170, the estimated coordinate (z_{estim,next}) associated with the point Pₙₑₓₜ is based on a decoded radius value r_{dec,next} associated with the point Pₙₑₓₜ and an elevation angle θₙₑₓₜ of a sensor that captured the point Pₙₑₓₜ.

In one exemplary embodiment of step 170, the estimated coordinate (z_{estim,next}) is also based on the sensor indices λₙ.

In one exemplary embodiment of step 170, the estimated coordinate (z_{estim,next}) is given by:

z_{estim,next}=r_{dec,next} tan θₙₑₓₜ

In one exemplary embodiment, the method further comprises, in step 180, encoding, in the bitstream B, residual azimuthal angles ϕ_{res,next} associated with the point Pₙₑₓₜ.

In an exemplary embodiment of a step 180, the azimuthal angle ϕₙₑₓₜ is quantized by:

ϕₙₑₓₜ=round(ϕ(Pₙₑₓₜ)/Δϕ)
where ϕ(Pₙₑₓₜ) is the original azimuthal angle of the point Pₙₑₓₜ. In this case, the set of discrete angles ϕᵢ(0≤i<I) is essentially defined by ϕᵢ=i*Δϕ and one obtains ϕᵢ₍ₙₑₓₜ₎=ϕₙₑₓₜ*Δϕ.

The order index o(Pₙₑₓₜ) of the point Pₙₑₓₜ is thus given by:

o(Pₙₑₓₜ)=ϕₙₑₓₜ*K+λₙₑₛₜ=round(ϕ(Pₙₑₛₜ)/Δϕ)*K+λₙₑₓₜ.

The residual azimuthal angle ϕ_{res,next} is given by:

ϕ_{res,next}=ϕ(Pₙₑₓₜ)−ϕₙₑₓₜ*Δϕ (3)

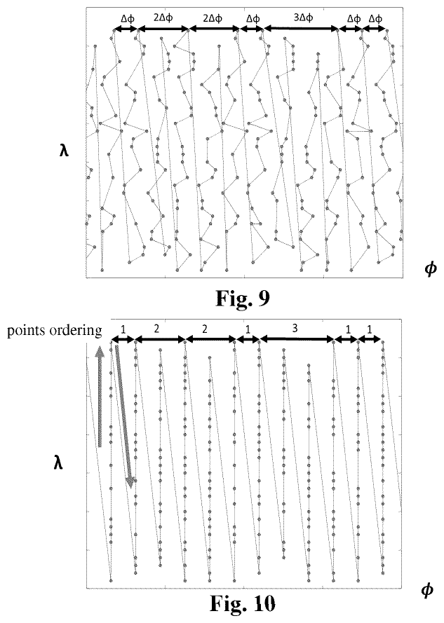

This exemplary embodiment of step 180 provides advantages because sometimes, in practice, not all points are captured at each capture time because a noise may be captured or because sensors may not be all perfectly aligned or because, for example, at least one laser beam of a spinning sensors head may not be reflected. Captured points may then look as depicted on FIG. 9. Quantizing the azimuthal angles ϕ(Pₙₑₓₜ) leads to an easier discrete representation of points in the angular coordinates (ϕ, λ) system as depicted on FIG. 10 that allows an easier path for ordering the points of the point cloud.

The residual azimuthal angle ϕ_{res,next} is encoded in the bitstream B, preferably by quantizing and/or entropy-coding.

This exemplary embodiment of step 180 also reduces the dynamic of the angular angles to be encoded into the bitstream because only a residual is encoded rather than the full range value. High compression performance is reached.

In one exemplary embodiment, the method further comprises, in step 185, obtaining the decoded azimuthal angle ϕ_{dec,next} based on the azimuthal angle ϕₙₑₓₜ.

In one exemplary embodiment of step 185, the decoded azimuthal angle ϕ_{dec,next} is given by:

ϕ_{dec,next}=ϕₙₑₓₜ*Δϕ

In one exemplary embodiment of step 185, the decoded azimuthal angle ϕ_{dec,next} is obtained based on azimuthal angle ϕₙₑₓₜ, the elementary azimuthal shift Δϕ and the residual azimuthal angle ϕ_{res,next}.

In one exemplary embodiment of step 185, the decoded azimuthal angle ϕ_{dec,next} is given by:

ϕ_{dec,next}=ϕₙₑₓₜ*Δϕ+ϕ_{res,next}

In one exemplary embodiment of step 185, the decoded azimuthal angle ϕ_{dec,next} is obtained based on the azimuthal angle ϕₙₑₓₜ, the elementary azimuthal shift Δϕ and a decoded angular residual ϕ_{dec,res,next} obtained by de-quantizing the quantized residual azimuthal angle ϕ_{res,next} given by equation 3.

In one exemplary embodiment of step 185, the decoded azimuthal angle ϕ_{dec,next} is given by:

ϕ_{dec,next}=ϕₙₑₓₜ*Δϕ+ϕ_{dec,res,next}

In one exemplary embodiment, the method further comprises, in step 190, obtaining the decoded radius value r_{dec,next} based on the encoded radius value rₙₑₓₜ.

In one exemplary embodiment of step 190, the decoded radius value r_{dec,next} is obtained by de-quantizing a quantized radius values rₙₑₓₜ.

Encoding Ndupn in the bitstream is advantageous, compared to encoding a series of values order index differences Δoₙₑₓₜ equal to zero, by offering a less complex process in case of the presence of many duplicated points and also by offering improved compression performance.

The number Ndupn of duplicated points is encoded in the bitstream B to indicates if a current point Pₙ is duplicated, i.e. have a same azimuthal angle and a same sensor index. But two duplicated points may not have same three-dimensional cartesian coordinates because they may have different radius.

In one exemplary embodiment, the method further comprises, in step 195, encoding in the bitstream B, a binary information BPₙ indicating whether duplicated points of a current point Pₙ have or not same three-dimensional cartesian coordinates.

This embodiment is advantageous because if the binary information BPₙ indicates (e.g. BPₙ=1) that duplicated points of the current BPₙ have same three-dimensional cartesian coordinates, steps 140 to 190 are bypassed reducing the cost for encoding the duplicated points of the points cloud having same three-dimensional cartesian coordinates.

In one exemplary embodiment of step 195, the binary information BPₙ is entropy-encoded.

In a variant, the binary data BP is entropy coded by a Context-Adaptive Binary Arithmetic Coder (like CABAC), and the contexts are selected according to the sensor index of the current point Pₙ.

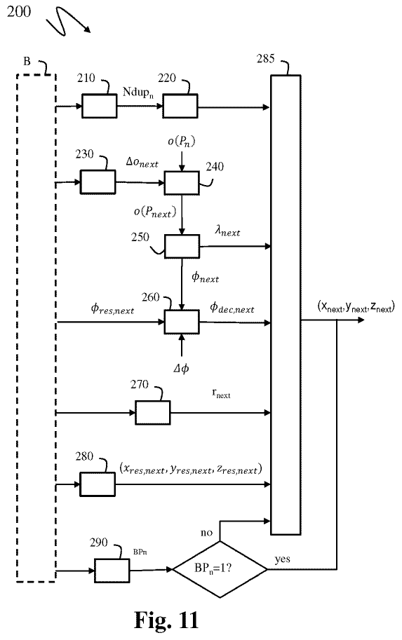

FIG. 11 illustrates a block diagram of steps of a method 200 of decoding a point cloud from a bitstream of encoded point cloud data in accordance with at least one exemplary embodiment.

Decoding points of a point cloud from a bitstream B requires information such a number M of encoded order index differences, an order index o(P₁) of a first point in the angular coordinates (ϕ, λ) system, and sensor setup parameters such as the elementary azimuthal shift Δϕ or an elevation angle θₖ associated with each sensor k. This information may also be decoded from the bitstream B or received by any other means or may be known beforehand by a decoder.

N points of the point cloud are decoded recursively.

The number M of encoded order index differences is lower than or equal to the number minus one N−1 of the points of the point cloud: M=N−1 when the list L of ordered points does not contain duplicated points, i.e. Ndupn=0 for any n(∀n=1 to N). M<N−1 when the list L of ordered points contains at least one duplicated point, i.e. Ndupn≠0 for at least one n.

In step 210, an information representative of a number Ndupₙ, associated with an already decoded current point Pₙ, is decoded from the bitstream B.

In step 220, Ndupₙ duplicated points are obtained, each duplicated point has the same azimuthal angle equals to the azimuthal angle ϕₙ of the already decoded current point Pₙ and a same sensor index equals to the azimuthal sensor index λₙ of the already decoded current point Pₙ.

In step 230, an order index difference Δoₙₑₓₜ is decoded from the bitstream B for a point Pₙₑₓₜ. The point Pₙₑₓₜ has an order index o(Pₙₑₓₜ) in the list L of ordered points different of the order index o(Pₙ) of the already decoded current point Pₙ.

In step 240, an order index o(Pₙₑₓₜ) is obtained for the point Pₙₑₓₜ by:

o(Pₙₑₓₜ)=o(Pₙ)+Δoₙₑₓₜ

The order index difference Δoₙₑₓₜ represents a difference between the order index o(Pₙₑₓₜ) of the point Pₙₑₓₜ and the order index o(Pₙ) of the already decoded current point Pₙ.

In step 250, a sensor index λₙₑₓₜ associated with a sensor that captured the point Pₙₑₓₜ and an azimuthal angle ϕₙₑₓₜ representing a capture angle of said sensor are obtained from the order index o(Pₙₑₓₜ).

In one exemplary embodiment of step 250, the sensor index λₙₑₓₜ and the azimuthal angles ϕₙₑₓₜ are obtained by equations (1) and (2).

The already decoded current (Pₙ) is then updated by considering the next point Pₙₑₓₜ as being a new already decoded current point Pₙ, and the steps 210, 220, 230, 240 and 250 are iterated until all the information representative of a number Ndupₙ associated with an already decoded current point are decoded.

In one exemplary embodiment, the method further comprises, in step 260, obtaining a decoded azimuthal angle ϕ_{dec,n} based on the azimuthal angle ϕₙₑₓₜ.

In one exemplary embodiment of step 260, the decoded azimuthal angle ϕ_{dec,next} is obtained based on the azimuthal angle ϕₙₑₓₜ and the elementary azimuthal shift Δϕ.

In one exemplary embodiment of step 260, the decoded azimuthal angle ϕ_{dec,next} is given by:

ϕ_{dec,next}=ϕₙₑₓₜ*Δϕ

In one exemplary embodiment of step 260, the decoded azimuthal angle ϕ_{dec,next} is obtained based on a residual azimuthal angle ϕ_{res,next} decoded from the bitstream B.

In one exemplary embodiment of step 260, the decoded azimuthal angle ϕ_{dec,next} is given by:

ϕ_{dec,next}=ϕₙₑₓₜ*Δϕ+ϕ_{res,next}

In one exemplary embodiment, the method further comprises, in step 270, decoding a radius value rₙₑₓₜ of spherical coordinates of the point Pₙₑₓₜ from the bitstream B.

In one exemplary embodiment of step 270, the radius value rₙₑₓₜ is de-quantized to obtain decoded radius values r_{dec,next}.

In one exemplary embodiment of step 270, the radius value rₙₑₓₜ is entropy-decoded and de-quantized to obtain decoded radius values r_{dec,next}.

In one exemplary embodiment, the method further comprises, in step 280, decoding a residual (x_{res,next}, y_{res,next}, z_{res,next}) of three-dimensional cartesian coordinates of the point Pₙₑₓₜ from a bitstream B

In one exemplary embodiment of step 280, the residual (x_{res,next}, y_{res,next}, z_{res,next}) is entropy-decoded.

In one exemplary embodiment, the method further comprises, in step 285, the three-dimensional cartesian coordinates (xₙₑₓₜ, yₙₑₓₜ, zₙₑₓₜ) of the point Pₙₑₓₜ are decoded based on the decoded residual (x_{res,next}, y_{res,next}, z_{res,next}) of the three-dimensional cartesian coordinates of the point Pₙₑₓₜ, the radius value rₙₑₓₜ, the decoded azimuthal angle ϕ_{dec,next} and the sensor index λₙₑₓₜ.

In one exemplary embodiment of step 285, the three-dimensional cartesian coordinates (xₙₑₓₜ, yₙₑₓₜ, zₙₑₓₜ) of the point Pₙₑₓₜ are the sums of the residuals (x_{res,next}, y_{res,next}, z_{res,next}) and estimated three-dimensional coordinates (xₑₛₜᵢₘ, yₑₛₜᵢₘ, zₑₛₜᵢₘ):

$$\{ \begin{matrix}{x}_{next} = {x}_{res , next} + {x}_{estim} \\ {y}_{next} = {y}_{res , next} + {y}_{estim} \\ {z}_{next} = {z}_{res , next} + {z}_{estim}\end{matrix}$$

In one exemplary embodiment of step 285, the estimated coordinates (xₑₛₜᵢₘ, yₑₛₜᵢₘ) associated with the point Pₙₑₓₜ are based on the azimuthal angle ϕₙₑₓₜ and the radius value rₙₑₓₜ.

In one exemplary embodiment of step 285, the estimated coordinates (xₑₛₜᵢₘ, yₑₛₜᵢₘ) are given by:

$$\{ \begin{matrix}{x}_{estim} = {r}_{next} * cos ( {ϕ}_{{ϕ}_{next}} ) \\ {y}_{estim} = {r}_{next} * sin ( {ϕ}_{{ϕ}_{next}} )\end{matrix}$$

In one exemplary embodiment of step 285, the estimated coordinates (x_{estim,next}, y_{estim,next}) are given by:

$$\{ \begin{matrix}{x}_{estim , next} = {r}_{dec , next} * cos ( {ϕ}_{dec , next} ) \\ {y}_{estim , next} = {r}_{dec , next} * sin ( {ϕ}_{dec , next} )\end{matrix}$$

where r_{dec,next} is a decoded radius value obtained from the radius values rₙₑₓₜ. For example, the decoded radius values r_{dec,next} may be obtained by de-quantizing the radius values rₙₑₓₜ.

In one exemplary embodiment of step 285, the estimated coordinate (zₑₛₜᵢₘ) associated with the point Pₙₑₓₜ is based on the radius value rₙₑₓₜ associated with point Pₙₑₓₜ and an elevation angle θₖ of a sensor k that captured the point Pₙₑₓₜ.

In one exemplary embodiment of step 285, the estimated coordinate (zₑₛₜᵢₘ) is given by:

zₑₛₜᵢₘ=rₙₑₓₜ tan θₖ

In one exemplary embodiment of step 285, the estimated coordinate (zₑₛₜᵢₘ) is also based on the sensor index λₙₑₓₜ.

In one exemplary embodiment of step 285, the estimated coordinate (zₑₛₜᵢₘ) is given by:

zₑₛₜᵢₘ=rₙₑₓₜ tan θ_{λnext}

In one exemplary embodiment, the method further comprises, in step 290, decoding, from the bitstream B, a binary information BPₙ indicating whether duplicated points of an already decoded current point Pₙ have or not same three-dimensional cartesian coordinates.

This embodiment is advantageous because if a binary information BPₙ indicates (e.g. BPₙ=1) that duplicated points of the already decoded current point Pₙ have same three-dimensional cartesian coordinates, steps 230 to 285 are bypassed and Ndupn new points of the point cloud are created with the three-dimensional cartesian coordinates of the current point Pₙ.

In one exemplary embodiment of step 290, the binary information BPₙ is entropy-decoded.

In a variant, the binary data BPₙ is entropy decoded by a Context-Adaptive Binary Arithmetic Coder (like CABAC), and the contexts are selected according to the sensor index of the current point Pₙ.

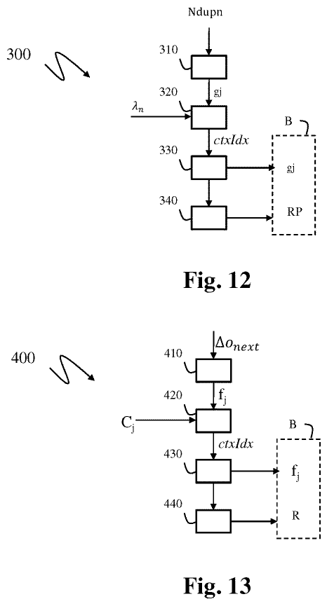

FIG. 12 illustrates a block diagram of steps of a method 300 of entropy-coding a number Ndupₙ of duplicated points in accordance with at least one exemplary embodiment of step 140.

In step 310, the number Ndupₙ of duplicated points is binarized into a series of binary data gj. The number of binary data gj of the series does not exceed a maximum bound NP_{flag}.

The maximum bound NP_{flag} is set to bound the number of arithmetically coded binary information per point and then bound the latency to obtain a next point Pₙₑₓₜ.

For each binary data gⱼ, in step 320, a context is selected based on the index j and the sensor index λₙ associated with the current point Pₙ, and each binary data gⱼ is context-adaptive entropy coded (step 330) in the bitstream B, based on the selected context.

Context-adaptive entropy encoding the number Ndupₙ provides efficient compression performance compared to other encoding technics such as a predictive tree encoding technique because such prediction-based encoding technics do not catch the intrinsic structure of the representation (ϕ, λ) of point locations. Such structure is captured by the exemplary embodiments of the present application by selecting contexts and entropy encoding the number Ndupₙ based on the selected context.

In one exemplary embodiment of step 310, the binarization of the number Ndupₙ is performed by a series of binary data gⱼ, for j>=0. A binary data gj equals to a particular value PV (for example gⱼ=1) to indicate if Ndupₙ is equal to j and does not equal to said specific value PV otherwise (for example gj=0). Then, a first binary g₀ is coded. For example, if g₀=PV, the coding of Ndupₙ is finished as Ndupₙ=1 has been coded; otherwise, if g₀≠PV, then a second binary data g₁ is coded. If g₁≠PV, then a third binary data g₂ is coded and so on. This is basically a unary coding of Ndupₙ.

In one exemplary embodiment, the method further comprises, in step 340, obtaining a residual RP as a difference between the number Ndupₙ, and the maximum bound (upper bound) NP_{flag}. Then, if a binary data g_{NPflag-1} is reached and is not equal to PV, then one has necessarily Ndupₙ≥NP_{flag} and the residual RP is given by: RP=Ndupₙ−NP_{flag}.

In one exemplary embodiment of step 340, the residual RP is encoded by using an exp-Golomb code.

In one exemplary embodiment of step 310, a binary data gⱼ is a flag and PV=1.

In one exemplary embodiment of step 330, a binary data gⱼ is entropy coded by a Context-Adaptive Binary Arithmetic Coder (like CABAC).

FIG. 13 illustrates a block diagram of steps of a method 400 of entropy-coding an order index difference Δoₙₑₓₜ in accordance with at least one exemplary embodiment.

In step 410, at least one binary data fⱼ is obtained by binarizing the order index difference Δoₙₑₓₜ.

For each binary data fⱼ, a context is selected (step 420) based on a distance Cⱼ between an azimuthal angle ϕ^{j} associated with the binary data fⱼ and an azimuthal angle of an already encoded point, and each binary data fⱼ is context-adaptive entropy coded (step 430) in the bitstream B, based on the selected context. As will become clear hereafter, similarly to the quantity ϕₙₑₓₜ, the quantity ϕ^{j} is abusively referred as an azimuthal angle even if it is an index between 0 and I−1 that points to a particular discrete angle among the ϕᵢ's.

Context-adaptive entropy encoding the order index difference provides efficient compression performance compared to other encoding technics such as a predictive tree encoding technique because such prediction-based encoding technics do not catch the intrinsic structure of the representation (ϕ, λ) of point locations. Such structure is captured by the exemplary embodiments of the present application by selecting contexts and entropy encoding the order index difference based on the selected context.

In one exemplary embodiment of step 410, the binarization of the order index difference Δoₙₑₓₜ is performed by a series of binary data fⱼ, for j>0. The binary data f₀ always equals 0 because the order index difference Δoₙₑₓₜ is strictly positive. The binary data f₀ is not encoded.

A binary data fj equals to a particular value PV (for example fⱼ=1) to indicate if Δoₙₑₓₜ is equal to j and does not equal to said specific value PV otherwise (for example fj=0). Then, a first binary f₁ is coded. For example, if f₁=PV, the coding of Δoₙₑₓₜ is finished as Δoₙₑₓₜ=1 has been coded; otherwise, if f₁≠PV, then a second binary data f₂ is coded. If f₂≠PV, then a third binary data f₃ is coded and so on. This is basically a unary coding of Δoₙₑₓₜ.

In one exemplary embodiment of step 410, when the points are ordered according to a lexicographic order based first on the azimuthal angle and then on the sensor index (FIG. 7), the azimuthal angle ϕ^{j} associated with a binary data fⱼ is the azimuthal angle ϕₙ associated with the current point Pₙ if j+c<K where c is the index of the current point modulo K (or equivalently c is the sensor index λₙ of the current point Pₙ); otherwise the azimuthal angle ϕ^{j} associated with a binary data fⱼ is the azimuthal angle

ϕ^{j}=ϕₙₑₓₜ+s
where s is an integer such that sK≤j+c<(s+1)K. Each binary data fⱼ is also associated with a sensor index λ^{j} which corresponds to the sensor index of a sensor that would have captured the point Pₙₑₓₜ in case fⱼ would be equal to PV, i.e. λ^{j}=λₙ+j mod K.

On FIG. 7, the order index difference Δoₙₑₓₜ equals 8 and is binarized into eight binary data f₁ to f₈ all not equal to PV except the last one f₈ which equals to PV. Note that f0 always equals 0 because, by definition the order of Pₙₑₓₜ is different from the order of Pₙ. Consequently, f₀ does not need to be coded and will be inferred to 0 by the decoder. Azimuthal angles ϕ¹ to ϕ⁶ respectively associated with binary data f₁ to f₆ are equal to the azimuthal angle ϕₙ and azimuthal angles ϕ⁷ and ϕ⁸ respectively associated with f₇ and f₈ are equal to ϕₙₑₓₜ.

In one exemplary embodiment of step 410, when the points are ordered according to a lexicographic order based first on the sensor index and then on the azimuthal angle (FIG. 8), the azimuthal angles ϕ^{j} associated with a binary data fⱼ is given by:

ϕ^{j}=ϕₙ+j

Each binary data fⱼ is also associated with a sensor index λ^{j} which corresponds to the sensor index of a sensor that would have captured the point Pₙₑₓₜ in case fⱼ would be equal to PV, i.e. λ^{j}=λₙ.

On FIG. 8, the order index difference Δoₙₑₓₜ equals 4 and is binarized into five binary data f₁ to f₄ all not equal to PV except the last one f₄ which equals to PV. Azimuthal angles ϕ¹ to ϕ⁴ respectively associated with binary data f₁ to f₄ are respectively ϕₙ+1, ϕₙ+2, ϕₙ+3 and ϕₙ+4=ϕₙₑₓₜ.

In one exemplary embodiment, the method further comprises, in step 440, obtaining a residual R as a difference between the order index difference Δoₙₑₓₜ and a maximum bound (upper bound) N_{flag}. Then, if a binary data f_{Nflag-1} is reached and is not equal to PV, then one has necessarily Δoₙₑₓₜ≥N_{flag} and the residual R is given by: R=Δoₙₑₓₜ−N_{flag}.

The maximum number of flags N_{flag} is set to bound the number of arithmetically coded binary information per point and then bound the latency to obtain a next point.

In one exemplary embodiment of step 440, the residual R is encoded by using an exp-Golomb code.

In one exemplary embodiment of step 410, a binary data fⱼ is a flag and PV=1.

In one exemplary embodiment of step 430, a binary data fⱼ is entropy coded by a Context-Adaptive Binary Arithmetic Coder (like CABAC).

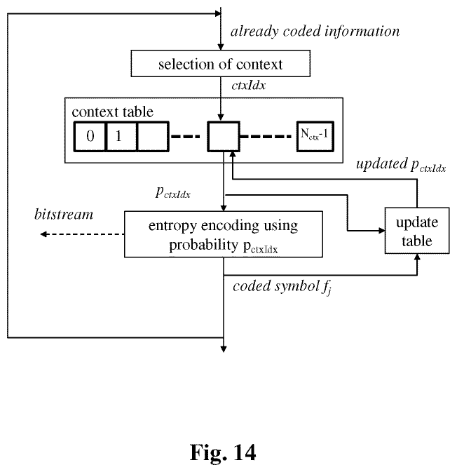

FIG. 14 illustrates schematically a block diagram of a Context-Adaptive Binary Arithmetic encoder.

Firstly, a context is selected by some selection process based on already coded information to provide a context index ctxIdx associated with each binary symbol fⱼ (or gj). A context table with N_{ctx} entries stores the probabilities associated with the contexts and the probability p_{ctxIdx} is obtained as the ctxIdx-th entry of the context table. A binary symbol fⱼ is encoded in the bitstream by an entropy coder using the probability p_{ctxIdx}.

Entropy coders are usually arithmetic coders but may be any other type of entropy coders like asymmetric numeral systems. In any case, optimal coders adds −log 2(p_{ctxIdx}) bits in the bitstream to encode fⱼ=1 or −log 2(1−p_{ctxIdx}) bits in the bitstream to encode fⱼ=0. Once the symbol fⱼ is encoded, the probability p_{ctxIdx} is updated by using an update process taking fⱼ and p_{ctxIdx} as entries; the update process is usually performed by using update tables. The updated probability replaces the ctxIdx-th entry of the context table. Then, another symbol can be encoded, and so on. The update loop back to the context table is a bottleneck in the coding workflow as another symbol can be encoded only after the update has been performed. For this reason, the memory access to the context table must be as quick as possible and minimizing the size of the context table helps easing its hardware implementation.

A Context-Adaptive Binary Arithmetic decoder performs essentially the same operations the Context-Adaptive Binary Arithmetic encoder except that the coded symbol fⱼ is decoded from the bitstream by an entropy decoder using the probability p_{ctxIdx}.

The choice of the adequate context, i.e. the probability p_{ctxIdx} that estimates at best the chance of the binary data fⱼ to be equals to PV, is essential to obtain good compression. Therefore, the context selection should use relevant already coded information and correlation to obtain this adequate context.

In one exemplary embodiment of step 420, the distance Cⱼ associated with a binary data fⱼ depends on an azimuthal angle ϕ^{j} associated with the binary data fⱼ and an (index of an) azimuthal angle ϕₚₑₙᵤₗₜ associated with a penultimate already coded point Pₚₑₙᵤₗₜ with a same sensor index as the sensor index λ^{j} associated with the binary data fⱼ. The current point Pₙ is never considered in the set of already coded points from which the penultimate already coded point Pₚₑₙᵤₗₜ is determined.

In one exemplary embodiment of step 420, the distance Cⱼ associated with a binary data fⱼ is given by:

Cⱼ=ϕ^{j}−ϕ_{penult,j} (4)

It is reminded that the two quantities ϕ^{j} and ϕ_{penult,j} are indices pointing to discrete angles in the set of discrete number of values ϕᵢ (i=0 to I−1).

On FIG. 7, the distance C₁=4 because the difference between, on one hand, the azimuthal angles ϕ_{penult,3}, associated with the penultimate already coded point (grey circle) with the sensor index λ¹=λₙ+1=3 associated with f₁, and, on the other hand, ϕ¹=ϕₙ equals 4. Then, C₂=3 because the difference between the azimuthal angles ϕ_{penult,4} associated with the penultimate already coded point with the sensor index λ²=λₙ+2=4 associated with f₂, and ϕ²=ϕₙ equals 3, and so on. Further, C₇=3 because the difference between the azimuthal angles ϕ_{penult,0} associated with the penultimate already coded point with the sensor index λ⁷=λₙ+7=9=0 mod K (here K=9) associated with f₇ and ϕ⁷=ϕₙ+1 equals 3. Finally, C₈=2 because the difference between the azimuthal angles ϕ_{penult,1} associated with the penultimate already coded point with the sensor index λ⁸=λₙ+8=10=1 mod K associated with f₈ and ϕ⁸=ϕₙₑₓₜ equals 2.

On FIG. 8, all binary data fⱼ are associated with the same sensor index λ^{j}=λₙ. The distance C₀=2 because the difference between the azimuthal angle ϕ_{penult,λ}_{ₙ} associated with the penultimate already coded point (grey circle) and ϕ⁰=ϕₙ equals 2. The distance C₁=3 because the difference between the azimuthal angles ϕ_{penult,λ}_{ₙ} associated with the penultimate already coded point and ϕ¹=ϕₙ+1 equals 3, and so on.

In one exemplary embodiment of step 420, the distance Cⱼ associated with a binary data fⱼ depends on an azimuthal angle ϕ^{j} associated with the binary data fⱼ and an (index of an) azimuthal angle ϕₐₗ associated with any of the already coded points not necessarily probed by the same sensor index as the sensor index of a current point Pₙ.

In one exemplary embodiment of step 420, the distance Cᵢ associated with a binary data fⱼ is given by:

Cⱼ=ϕ^{j}−ϕₐₗ

In one exemplary embodiment of step 420, a context index ctxIdx of a context table associated with a binary data fⱼ equals to the distance Cⱼ.

In one exemplary embodiment of step 420, a context index ctxIdx is capped by a threshold th1 to limit the number of contexts:

ctxIdx=min(Cⱼ, th1)

For example, th1 may be equal to 6.

Limiting the number of contexts is important in order to ease implementation, limit memory use and also to ensure statistical relevance of the probabilities p_{ctxIdx} as high values of j may not be often visited.

In one exemplary embodiment of step 420, a context index ctxIdx for a binary data fⱼ depends on the rank j of said binary data in a series of binary data representing the order index difference Δoₙₑₓₜ.

Because the statistics of the binary data fⱼ tend to become weakly dependent on the rank j for high j, one may take advantage of this weak dependence to limit the number of contexts.

Moreover, dependency between the context index ctxIdx and the value j provides advantages for the following reasons: the statistics of each binary flag fⱼ being equal to PV or not depend on the index j. Typically the probability P(fⱼ=PV|f₀ to fⱼ₋₁≠PV) decreases with j. Therefore, one obtains better probabilities p_{ctxIdx} by making the index ctxIdx depends on j

In one exemplary embodiment of step 420, a context index ctxIdx is given by:

ctxIdx=min(Cⱼ, th1)*(th2+1)+min(j,th2)
where th₂ is a second threshold such as to have (th1+1)*(th₂+1) contexts. For example, one may take th2 equal to 3.

In one exemplary embodiment of step 420, the context index ctxIdx depends on the sensor index λj associated with the binary data fⱼ.

The statistics of each binary data fⱼ being equal or not to PV also depends on the sensor index probing the location of where the next point would be, should the binary data fⱼ equals to PV. For example, sensors directed to the ground almost always probe something (mostly the road), but sensors directed to the sky tend to probe more object less often, like buildings or trees. But dependency between the context index ctxIdx and the sensor index λ^{j} associated with the binary data fⱼ multiplies the number of contexts by K (the number of sensors) and likely provides a very high number of contexts as typical Lidar head have 16, 32 or even 64 laser beams.

In one exemplary embodiment of step 420, the sensors with close elevation angles are regrouped together into packs, because all sensors of the same pack tend to probe similar objects.

Each sensor whose index is λ has a corresponding pack index λ_{pack}(λ), and the binary data fⱼ associated the sensor index λ^{j} has an associated pack index with pack index λ_{j,pack}.

Grouping the sensors into packs limits the number of contexts.

In one exemplary embodiment of step 420, the context index ctxIdx is given by:

ctxIdx=(min(Cⱼ, th)*(th₂+1)+min(j,th₂))*N_{pack}+λ_{j,pack}
where N_{pack} is a number of packs.

The number of contexts becomes (th+1)*(th₂+1)*N_{pack}.

In a variant, a pack index λ_{j,pack} is given by:

λ_{j,pack}=floor(λ^{j}*N_{pack}/K)
such that λ_{j,pack} belongs to [0, N_{pack}−1].

The number of contexts may then be tuned by setting adequate values to th1 and/or th₂ and/or N_{pack}. These values may be coded in the bitstream B. For example, with respective values 6, 3 and 4, one gets 7*4*4=112 which is an acceptable number of contexts.

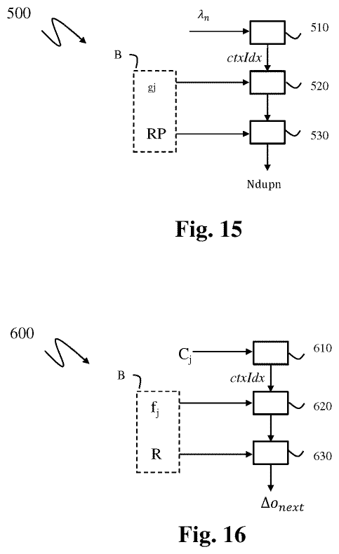

FIG. 15 shows a block diagram of steps of a method 500 of entropy-decoding a number of duplicated points Ndupₙ in accordance with at least one exemplary embodiment.

Decoding, from the bitstream B, a number Ndupₙ of duplicated points associated with a decoded current point Pₙ comprises decoding a series of binary data gⱼ from the bitstream B. The series of binary data comprises a number of bits lower than or equal to a maximum bound (upper bound) NP_{flag}. For each binary data gⱼ, in step 510, the method selects a context based on based on the index j and the sensor index λₙ associated with the current point Pₙ. The method then context-based entropy decodes (step 520) said at least one binary data gⱼ based on the selected contexts and probability information relative to the binary data gⱼ and decoded from the bitstream B. Next, the number Ndupₙ of duplicated points is obtained (step 530) from the context-based entropy decoded binary data gⱼ.

In one exemplary embodiment, in step 530, if a binary data g_{NPflag-1} is reached and is not equal to PV, then a residual RP is also decoded from the bitstream B and the number Ndupₙ of duplicated points is obtained by Ndupₙ=RP+NP_{flag}.

In one exemplary embodiment of step 530, the residual RP is decoded by using an exp-Golomb code.

Context selection of steps 320 and 510 are the same. Therefore, all exemplary embodiments and variants of step 320 apply to step 510.

In one exemplary embodiment of step 520, a binary data gⱼ is entropy decoded by a Context-Adaptive Binary Arithmetic decoder (like CABAC). Context-based entropy decoding (step 520) a binary data gⱼ based on a selected context is essentially the same as the Context-based entropy encoding on FIG. 14.

Basically, entropy decoders decode −log 2(p_{ctxIdx}) bits from the bitstream B to decode a binary value gⱼ=1 or −log 2(1−p_{ctxIdx}) bits from the bitstream B to decode gⱼ=0. Once the symbol fⱼ is decoded, the probability p_{ctxIdx} is updated by using an update process taking gⱼ and p_{ctxIdx} as entries; the update process is usually performed by using update tables. The updated probability replaces the ctxIdx-th entry of the context table. Then, another symbol can be decoded, and so on. The update loop back to the context table is a bottleneck in the coding workflow as another symbol can be decoded only after the update has been performed. For this reason, the memory access to the context table must be as quick as possible and minimizing the size of the context table helps easing its hardware implementation.

In one exemplary embodiment of step 530, the number of duplicated points Ndupₙ is decoded by a unary decoding of the at least one decoded binary data gⱼ.

For example, if a first g₀=PV, the decoding is finished as Ndupₙ=0 has been decoded; otherwise, if g₀≠PV, then a second binary data g₁ is decoded otherwise Ndupₙ=1 and the decoding is finished. If g₁≠PV, then a third binary data g₂ is decoded and so on.

FIG. 16 shows a block diagram of steps of a method 600 of entropy-decoding an order index difference Δoₙₑₓₜ in accordance with at least one exemplary embodiment.

Decoding, from the bitstream B, a point Pₙₑₓₜ of a point cloud comprises decoding, from the bitstream B, an order index difference Δoₙₑₓₜ representing a difference between an order index o(Pₙₑₓₜ) associated with the point Pₙₑₓₜ and another order index o(Pₙ) associated with a current point Pₙ.

Decoding an order index difference Δoₙₑₓₜ comprises decoding at least one binary data fⱼ from the bitstream B. For each binary data fⱼ, the method selects (step 610) a context based on a distance Cⱼ between a azimuthal angle ϕ^{j} associated with the binary data fⱼ and an azimuthal angle (ϕₚₑₙᵤₗₜ or ϕₐₗ) of an already decoded point. The method then context-based entropy decodes (step 620) said at least one binary data fⱼ based on the selected contexts and probability information relative to the binary data fⱼ and decoded from the bitstream B. Next, the order index difference Δoₙₑₓₜ is obtained (step 630) from the context-based entropy decoded binary data fⱼ.

In one exemplary embodiment, the method further comprises, in step 630, if a binary data f_{Nflag-1} reached and is not equal to PV, then a residual R is also decoded from the bitstream B and the order index difference Δoₙₑₓₜ is obtained by Δoₙₑₓₜ=R+N_{flag}.

In one exemplary embodiment of step 630, the residual R is decoded by using an exp-Golomb code.

Context selection of steps 420 and 610 are the same. Therefore, all exemplary embodiments and variants of step 420 apply to step 610.

In one exemplary embodiment of step 620, a binary data fⱼ is entropy decoded by a Context-Adaptive Binary Arithmetic decoder (like CABAC). Context-based entropy decoding (step 620) a binary data fⱼ based on a selected context is essentially the same as the Context-based entropy encoding on FIG. 14.

Basically, entropy decoders decode −log 2(p_{ctxIdx}) bits from the bitstream B to decode a binary value fⱼ=1 or −log 2(1−p_{ctxIdx}) bits from the bitstream B to decode fⱼ=0. Once the symbol fⱼ is decoded, the probability p_{ctxIdx} is updated by using an update process taking fⱼ and p_{ctxIdx} as entries; the update process is usually performed by using update tables. The updated probability replaces the ctxIdx-th entry of the context table. Then, another symbol can be decoded, and so on. The update loop back to the context table is a bottleneck in the coding workflow as another symbol can be decoded only after the update has been performed. For this reason, the memory access to the context table must be as quick as possible and minimizing the size of the context table helps easing its hardware implementation.

In one exemplary embodiment of step 630, the order index difference Δoₙₑₓₜ is decoded by a unary decoding of the at least one decoded binary data fⱼ.

For example, if a first f₁=PV, the decoding is finished as Δoₙₑₓₜ=0 has been decoded; otherwise, if f₁≠PV, then a second binary data f₂ is decoded otherwise Δoₙₑₓₜ=1 and the decoding is finished. If f₂≠PV, then a third binary data f₃ is decoded and so on.

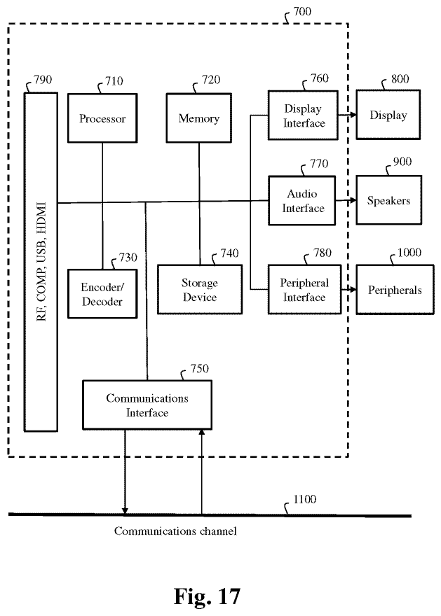

FIG. 17 shows a schematic block diagram illustrating an example of a system in which various aspects and exemplary embodiments are implemented.

System 700 may be embedded as one or more devices including the various components described below. In various embodiments, the system 700 may be configured to implement one or more of the aspects described in the present application.

Examples of equipment that may form all or part of the system 700 include personal computers, laptops, smartphones, tablet computers, digital multimedia set top boxes, digital television receivers, personal video recording systems, connected home appliances, connected vehicles and their associated processing systems, head mounted display devices (HMD, see-through glasses), projectors (beamers), “caves” (system including multiple displays), servers, video encoders, video decoders, post-processors processing output from a video decoder, pre-processors providing input to a video encoder, web servers, set-top boxes, and any other device for processing a point cloud, a video or an image or other communication devices. Elements of system 700, singly or in combination, may be embodied in a single integrated circuit (IC), multiple ICs, and/or discrete components. For example, in at least one embodiment, the processing and encoder/decoder elements of system 700 may be distributed across multiple ICs and/or discrete components. In various embodiments, the system 700 may be communicatively coupled to other similar systems, or to other electronic devices, via, for example, a communications bus or through dedicated input and/or output ports.

The system 700 may include at least one processor 710 configured to execute instructions loaded therein for implementing, for example, the various aspects described in the present application. Processor 710 may include embedded memory, input output interface, and various other circuitries as known in the art. The system 700 may include at least one memory 720 (for example a volatile memory device and/or a non-volatile memory device). System 700 may include a storage device 740, which may include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random-Access Memory (DRAM), Static Random-Access Memory (SRAM), flash, magnetic disk drive, and/or optical disk drive. The storage device 740 may include an internal storage device, an attached storage device, and/or a network accessible storage device, as non-limiting examples.

The system 700 may include an encoder/decoder module 730 configured, for example, to process data to provide encoded/decoded point cloud geometry data, and the encoder/decoder module 730 may include its own processor and memory. The encoder/decoder module 730 may represent module(s) that may be included in a device to perform the encoding and/or decoding functions. As is known, a device may include one or both of the encoding and decoding modules. Additionally, encoder/decoder module 730 may be implemented as a separate element of system 700 or may be incorporated within processor 710 as a combination of hardware and software.

Program code to be loaded onto processor 710 or encoder/decoder 730 to perform the various aspects described in the present application may be stored in storage device 740 and subsequently loaded onto memory 720 for execution by processor 710. In accordance with various embodiments, one or more of processor 710, memory 720, storage device 740, and encoder/decoder module 730 may store one or more of various items during the performance of the processes described in the present application. Such stored items may include, but are not limited to, a point cloud frame, encoded/decoded geometry/attributes videos/images or portions of the encoded/decoded geometry/attribute video/images, a bitstream, matrices, variables, and intermediate or final results from the processing of equations, formulas, operations, and operational logic.

In several embodiments, memory inside of the processor 710 and/or the encoder/decoder module 730 may be used to store instructions and to provide working memory for processing that may be performed during encoding or decoding.

In other embodiments, however, a memory external to the processing device (for example, the processing device may be either the processor 710 or the encoder/decoder module 730) may be used for one or more of these functions. The external memory may be the memory 720 and/or the storage device 740, for example, a dynamic volatile memory and/or a non-volatile flash memory. In several embodiments, an external non-volatile flash memory may be used to store the operating system of a television. In at least one embodiment, a fast external dynamic volatile memory such as a RAM may be used as working memory for video coding and decoding operations, such as for MPEG-2 part 2 (also known as ITU-T Recommendation H.262 and ISO/IEC 13818-2, also known as MPEG-2 Video), HEVC (High Efficiency Video coding), VVC (Versatile Video Coding), or MPEG-I part 5 or part 9.

The input to the elements of system 700 may be provided through various input devices as indicated in block 790. Such input devices include, but are not limited to, (i) an RF portion that may receive an RF signal transmitted, for example, over the air by a broadcaster, (ii) a Composite input terminal, (iii) a USB input terminal, and/or (iv) an HDMI input terminal.

In various embodiments, the input devices of block 790 may have associated respective input processing elements as known in the art. For example, the RF portion may be associated with elements necessary for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which may be referred to as a channel in certain embodiments, (iv) demodulating the down-converted and band-limited signal, (v) performing error correction, and (vi) demultiplexing to select the desired stream of data packets. The RF portion of various embodiments may include one or more elements to perform these functions, for example, frequency selectors, signal selectors, band-limiters, channel selectors, filters, downconverters, demodulators, error correctors, and de-multiplexers. The RF portion may include a tuner that performs various of these functions, including, for example, down-converting the received signal to a lower frequency (for example, an intermediate frequency or a near-baseband frequency) or to baseband.

In one set-top box embodiment, the RF portion and its associated input processing element may receive an RF signal transmitted over a wired (for example, cable) medium. Then, the RF portion may perform frequency selection by filtering, down-converting, and filtering again to a desired frequency band.

Various embodiments rearrange the order of the above-described (and other) elements, remove some of these elements, and/or add other elements performing similar or different functions.

Adding elements may include inserting elements in between existing elements, such as, for example, inserting amplifiers and an analog-to-digital converter. In various embodiments, the RF portion may include an antenna.

Additionally, the USB and/or HDMI terminals may include respective interface processors for connecting system 700 to other electronic devices across USB and/or HDMI connections. In some embodiments, various aspects of input processing, for example, Reed-Solomon error correction, may be implemented, for example, within a separate input processing IC or within processor 710 as necessary. Similarly, aspects of USB or HDMI interface processing may be implemented within separate interface ICs or within processor 710 as necessary. The demodulated, error corrected, and demultiplexed stream may be provided to various processing elements, including, for example, processor 710, and encoder/decoder 730 operating in combination with the memory and storage elements to process the data stream as necessary for presentation on an output device.

Various elements of system 700 may be provided within an integrated housing. Within the integrated housing, the various elements may be interconnected and transmit data therebetween using suitable connection arrangement 790, for example, an internal bus as known in the art, including the I2C bus, wiring, and printed circuit boards.

The system 700 may include communication interface 750 that enables communication with other devices via communication channel 1100. The communication interface 750 may include, but is not limited to, a transceiver configured to transmit and to receive data over communication channel 1100. The communication interface 750 may include, but is not limited to, a modem or network card and the communication channel 1100 may be implemented, for example, within a wired and/or a wireless medium.

Data may be streamed to the system 700, in various embodiments, using a Wi-Fi network such as IEEE 802.11. The Wi-Fi signal of these embodiments may be received over the communications channel 1100 and the communications interface 750 which are adapted for Wi-Fi communications. The communications channel 1100 of these embodiments may be typically connected to an access point or router that provides access to outside networks including the Internet for allowing streaming applications and other over-the-top communications.

Other embodiments may provide streamed data to the system 700 using a set-top box that delivers the data over the HDMI connection of the input block 790.

Still other embodiments may provide streamed data to the system 700 using the RF connection of the input block 790.

The streamed data may be used as a way for signaling information used by the system 700. The signaling information may comprise the bitstream B and/or information such a number of points of a point cloud, coordinates or order o(P₁) of a first point in the angular coordinates (ϕ, λ) system, a number Ndupₙ of duplicated points, a binary information BPₙ, a order index difference and/or sensor setup parameters such as such as an elementary azimuthal shift Δϕ or an elevation angle θₖ associated with a sensor of the Lidar head 10.

It is to be appreciated that signaling may be accomplished in a variety of ways. For example, one or more syntax elements, flags, and so forth may be used to signal information to a corresponding decoder in various embodiments.

The system 700 may provide an output signal to various output devices, including a display 800, speakers 900, and other peripheral devices 1000. The other peripheral devices 1000 may include, in various examples of embodiments, one or more of a stand-alone DVR, a disk player, a stereo system, a lighting system, and other devices that provide a function based on the output of the system 700.

In various embodiments, control signals may be communicated between the system 700 and the display 800, speakers 900, or other peripheral devices 1000 using signaling such as AV.Link (Audio/Video Link), CEC (Consumer Electronics Control), or other communications protocols that enable device-to-device control with or without user intervention.

The output devices may be communicatively coupled to system 700 via dedicated connections through respective interfaces 760, 770, and 780.

Alternatively, the output devices may be connected to system 700 using the communications channel 1100 via the communications interface 750. The display 800 and speakers 900 may be integrated in a single unit with the other components of system 700 in an electronic device such as, for example, a television.

In various embodiments, the display interface 760 may include a display driver, such as, for example, a timing controller (T Con) chip.

The display 800 and speaker 900 may alternatively be separate from one or more of the other components, for example, if the RF portion of input 790 is part of a separate set-top box. In various embodiments in which the display 800 and speakers 900 may be external components, the output signal may be provided via dedicated output connections, including, for example, HDMI ports, USB ports, or COMP outputs.

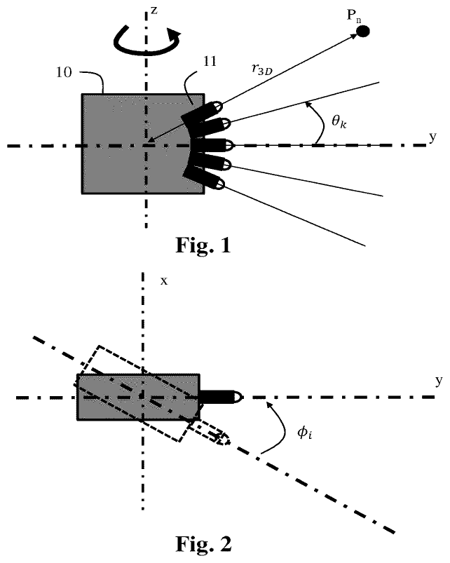

In FIG. 1-17, various methods are described herein, and each of the methods includes one or more steps or actions for achieving the described method. Unless a specific order of steps or actions is required for proper operation of the method, the order and/or use of specific steps and/or actions may be modified or combined.

Some examples are described with regard to block diagrams and/or operational flowcharts. Each block represents a circuit element, module, or portion of code which includes one or more executable instructions for implementing the specified logical function(s). It should also be noted that in other implementations, the function(s) noted in the blocks may occur out of the indicated order. For example, two blocks shown in succession may, in fact, be executed substantially concurrently or the blocks may sometimes be executed in the reverse order, depending on the functionality involved.

The implementations and aspects described herein may be implemented in, for example, a method or a process, an apparatus, a computer program, a data stream, a bitstream, or a signal. Even if only discussed in the context of a single form of implementation (for example, discussed only as a method), the implementation of features discussed may also be implemented in other forms (for example, an apparatus or computer program).

The methods may be implemented in, for example, a processor, which refers to processing devices in general, including, for example, a computer, a microprocessor, an integrated circuit, or a programmable logic device. Processors also include communication devices.

Additionally, the methods may be implemented by instructions being performed by a processor, and such instructions (and/or data values produced by an implementation) may be stored on a computer readable storage medium. A computer readable storage medium may take the form of a computer readable program product embodied in one or more computer readable medium(s) and having computer readable program code embodied thereon that is executable by a computer. A computer readable storage medium as used herein may be considered a non-transitory storage medium given the inherent capability to store the information therein as well as the inherent capability to provide retrieval of the information therefrom. A computer readable storage medium may be, for example, but is not limited to, an electronic, magnetic, optical, electromagnetic, infrared, or semiconductor system, apparatus, or device, or any suitable combination of the foregoing. It is to be appreciated that the following, while providing more specific examples of computer readable storage mediums to which the present embodiments may be applied, is merely an illustrative and not an exhaustive listing as is readily appreciated by one of ordinary skill in the art: a portable computer diskette; a hard disk; a read-only memory (ROM); an erasable programmable read-only memory (EPROM or Flash memory); a portable compact disc read-only memory (CD-ROM); an optical storage device; a magnetic storage device; or any suitable combination of the foregoing.

The instructions may form an application program tangibly embodied on a processor-readable medium.

Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

An apparatus may be implemented in, for example, appropriate hardware, software, and firmware. Examples of such apparatus include personal computers, laptops, smartphones, tablet computers, digital multimedia set top boxes, digital television receivers, personal video recording systems, connected home appliances, head mounted display devices (HMD, see-through glasses), projectors (beamers), “caves” (system including multiple displays), servers, video encoders, video decoders, post-processors processing output from a video decoder, pre-processors providing input to a video encoder, web servers, set-top boxes, and any other device for processing a point cloud, a video or an image or other communication devices. As should be clear, the equipment may be mobile and even installed in a mobile vehicle.

Computer software may be implemented by the processor 710 or by hardware, or by a combination of hardware and software. As a non-limiting example, the embodiments may be also implemented by one or more integrated circuits. The memory 720 may be of any type appropriate to the technical environment and may be implemented using any appropriate data storage technology, such as optical memory devices, magnetic memory devices, semiconductor-based memory devices, fixed memory, and removable memory, as non-limiting examples. The processor 710 may be of any type appropriate to the technical environment, and may encompass one or more of microprocessors, general purpose computers, special purpose computers, and processors based on a multi-core architecture, as non-limiting examples.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

The terminology used herein is for the purpose of describing particular embodiments only and is not intended to be limiting. As used herein, the singular forms “a”, “an”, and “the” may be intended to include the plural forms as well, unless the context clearly indicates otherwise. The terms “includes/comprises” and/or “including/comprising” when used in this specification, may specify the presence of stated, for example, features, integers, steps, operations, elements, and/or components but do not preclude the presence or addition of one or more other features, integers, steps, operations, elements, components, and/or groups thereof. Moreover, when an element is referred to as being “responsive” or “connected” to another element, it may be directly responsive or connected to the other element, or intervening elements may be present. In contrast, when an element is referred to as being “directly responsive” or “directly connected” to other element, there are no intervening elements present.

It is to be appreciated that the use of any of the symbol/term “/”, “and/or”, and “at least one of”, for example, in the cases of “A/B”, “A and/or B” and “at least one of A and B”, may be intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Various numeric values may be used in the present application. The specific values may be for example purposes and the aspects described are not limited to these specific values.

Although the terms first, second, etc. may be used herein to describe various elements, these elements are not limited by these terms. These terms are only used to distinguish one element from another. For example, a first element could be termed a second element, and, similarly, a second element could be termed a first element without departing from the teachings of this application. No ordering is implied between a first element and a second element.

Reference to “one exemplary embodiment” or “an exemplary embodiment” or “one implementation” or “an implementation”, as well as other variations thereof, is frequently used to convey that a particular feature, structure, characteristic, and so forth (described in connection with the embodiment/implementation) is included in at least one embodiment/implementation. Thus, the appearances of the phrase “in one exemplary embodiment” or “in an exemplary embodiment” or “in one implementation” or “in an implementation”, as well any other variations, appearing in various places throughout this application are not necessarily all referring to the same embodiment.

Similarly, reference herein to “in accordance with an exemplary embodiment/example/implementation” or “in an exemplary embodiment/example/implementation”, as well as other variations thereof, is frequently used to convey that a particular feature, structure, or characteristic (described in connection with the exemplary embodiment/example/implementation) may be included in at least one exemplary embodiment/example/implementation. Thus, the appearances of the expression “in accordance with an exemplary embodiment/example/implementation” or “in an exemplary embodiment/example/implementation” in various places in the specification are not necessarily all referring to the same exemplary embodiment/example/implementation, nor are separate or alternative exemplary embodiment/examples/implementation necessarily mutually exclusive of other exemplary embodiments/examples/implementation.

Reference numerals appearing in the claims are by way of illustration only and shall have no limiting effect on the scope of the claims. Although not explicitly described, the present embodiments/examples and variants may be employed in any combination or sub-combination.

When a figure is presented as a flow diagram, it also provides a block diagram of a corresponding apparatus. Similarly, when a figure is presented as a block diagram, it also provides a flow diagram of a corresponding method/process.

Although some of the diagrams include arrows on communication paths to show a primary direction of communication, communication may occur in the opposite direction to the depicted arrows.

Various implementations involve decoding. “Decoding”, as used in this application, may encompass all or part of the processes performed, for example, on a received point cloud frame (including possibly a received bitstream which encodes one or more point cloud frames) in order to produce a final output suitable for display or for further processing in the reconstructed point cloud domain. In various embodiments, such processes include one or more of the processes typically performed by a decoder. In various embodiments, such processes also, or alternatively, include processes performed by a decoder of various implementations described in this application, for example,

As further examples, in one embodiment “decoding” may refer only to de-quantizing, in one embodiment “decoding” may refer to entropy decoding, in another embodiment “decoding” may refer only to differential decoding, and in another embodiment “decoding” may refer to combinations of de-quantizing, entropy decoding and differential decoding. Whether the phrase “decoding process” may be intended to refer specifically to a subset of operations or generally to the broader decoding process is clear based on the context of the specific descriptions.

Various implementations involve encoding. In an analogous way to the above discussion about “decoding”, “encoding” as used in this application may encompass all or part of the processes performed, for example, on an input point cloud frame in order to produce an encoded bitstream. In various embodiments, such processes include one or more of the processes typically performed by an encoder. In various embodiments, such processes also, or alternatively, include processes performed by an encoder of various implementations described in this application.

As further examples, in one embodiment “encoding” may refer only to quantizing, in one embodiment “encoding” may refer only to entropy encoding, in another embodiment “encoding” may refer only to differential encoding, and in another embodiment “encoding” may refer to combinations of quantizing, differential encoding and entropy encoding. Whether the phrase “encoding process” may be intended to refer specifically to a subset of operations or generally to the broader encoding process is clear based on the context of the specific descriptions.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

Also, as used herein, the word “signal” refers to, among other things, indicating something to a corresponding decoder. For example, in certain embodiments the encoder signals a particular information such a number of points of the point cloud or coordinates or order o(P₁) of a first point in the 2D coordinates (ϕ, λ) system, a number of duplicated points, an order index difference or sensor setup parameters such as the elementary azimuthal shift Δϕ or an elevation angle θₖ associated with a sensor k. In this way, in an embodiment the same parameter may be used at both the encoder side and the decoder side. Thus, for example, an encoder may transmit (explicit signaling) a particular parameter to the decoder so that the decoder may use the same particular parameter. Conversely, if the decoder already has the particular parameter as well as others, then signaling may be used without transmitting (implicit signaling) to simply allow the decoder to know and select the particular parameter. By avoiding transmission of any actual functions, a bit savings is realized in various embodiments. It is to be appreciated that signaling may be accomplished in a variety of ways. For example, one or more syntax elements, flags, and so forth are used to signal information to a corresponding decoder in various embodiments. While the preceding relates to the verb form of the word “signal”, the word “signal” may also be used herein as a noun.

A number of implementations have been described. Nevertheless, various modifications may be made. For example, elements of different implementations may be combined, supplemented, modified, or removed to produce other implementations. Additionally, other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method of encoding a point cloud captured by a set of sensors into a bitstream of encoded point cloud data, comprising:
obtaining, by an encoder for a point of the point cloud, a sensor index (λₙ) associated with a sensor that captured the point, an azimuthal angle (ϕₙ) representing a capture angle of the sensor, each captured point being represented by a point in a 2D discrete angular plane in which the sensor index (λₙ) is a coordinate of a first axis of the 2D discrete angular plane and the azimuthal angle (ϕₙ) is a coordinate of a second axis of the 2D discrete angular plane;
obtaining, by the encoder, a list of ordered points of the point cloud by ordering points of the point cloud according to a lexicographic order based first on azimuthal angles (ϕₙ) and then on sensor indices (λₙ) or inversely, an order index being associated with each point of the point cloud according to a rank of the each point in the list of ordered points;
obtaining, by the encoder, a next point (Pₙₑₓₜ) following a current point (Pₙ) in the list of ordered points, and having an order index (o(Pₙₑₓₜ)) different of an order index (o(Pₙ)) of the current point (Pₙ), and obtaining, by the encoder, a number (Ndupₙ) of duplicated points equals to a number of points following the current point (Pₙ) that have an order index equals to the order index (o(Pₙ)) of the current point (Pₙ);
encoding, by the encoder in the bitstream, the number (Ndupₙ) of duplicated points;
obtaining and encoding, by the encoder in the bitstream, an order index difference (Δoₙₑₓₜ) representing a difference between the order index (o(Pₙₑₓₜ)) of the next point (Pₙₑₓₜ) and the order index (o(Pₙ)) of the current point (Pₙ); and
updating, by the encoder, the current point (Pₙ) by considering the next point (Pₙₑₓₜ) as being a new current point (Pₙ).

2. The method of claim 1, wherein encoding the number (Ndupₙ) of duplicated points comprises:
binarizing the number (Ndupₙ) of duplicated points into a series of binary data, a number of the series of binary data being lower than or equal to a maximum bound; and
entropy coding each binary data of the series of binary data.

3. A method of decoding a point cloud captured by a set of sensors from a bitstream of encoded point cloud data, comprising:
decoding, by a decoder from the bitstream, an information representative of a number (Ndupₙ) of duplicated points associated with an already decoded current point (Pₙ) of the point cloud;
reconstructing, by the decoder, a number of duplicated points, which equals to the decoded number (Ndupₙ) of duplicated points, each duplicated point having a same azimuthal angle equaling to an azimuthal angle of the already decoded current point (Pₙ), and a sensor index equaling to a sensor index of the already decoded current point (Pₙ);
decoding, by the decoder, an order index difference (Δoₙₑₓₜ) from the bitstream for a next point (Pₙₑₓₜ), the next point (Pₙₑₓₜ) having an order index (o(Pₙₑₓₜ)) different of an order index (o(Pₙ)) of the already decoded current point (Pₙ), an order index being associated with a point of the point cloud according to a rank of the point in a list of ordered points obtained by ordering points of the point cloud according to a lexicographic order based first on azimuthal angles and then on sensor indices associated with the points of the point cloud, or inversely;
obtaining, by the decoder, an order index (o(Pₙₑₓₜ)) for the next point (Pₙₑₓₜ) from the decoded order index difference (Δoₙₑₓₜ) and the order index (o(Pₙ)) of the already decoded current point (Pₙ);
obtaining, by the decoder, a sensor index (λₙₑₓₜ) associated with a sensor that captured the next point (Pₙₑₓₜ) and an azimuthal angle (ϕₙₑₓₜ) representing a capture angle of the sensor from the order index (o(Pₙₑₓₜ)) of the next point (Pₙₑₓₜ); and
updating, by the decoder, the already decoded current (Pₙ) by considering the next point (Pₙₑₓₜ) as being a new already decoded current point.

4. The method of claim 3, wherein decoding the number (Ndupₙ) of duplicated points comprises:
entropy decoding each binary data of a series of binary data, a number of the series of binary data being lower than or equal to a maximum bound; and
obtaining the number (Ndupₙ) of duplicated points by a unary decoding of at least one decoded binary data of the series of binary data.

5. The method of claim 2, wherein each binary data is context-adaptive arithmetic coded such that a context used to code a binary data depends on a sensor index associated with the current point.

6. The method of claim 2, wherein encoding the number (Ndupₙ) of duplicated points further comprises encoding a residual obtained as a difference between the number (Ndupₙ) of duplicated points and the maximum bound.

7. The method of claim 6, wherein encoding the residual comprises:
encoding the residual by using an expGolomb code.

8. The method of claim 1, further comprising:
encoding, by the encoder in the bitstream, a binary information (BPₙ) indicating whether duplicated points of the current point (Pₙ) have or not same three-dimensional coordinates.

9. An apparatus of encoding a point cloud captured by a set of sensors into a bitstream of encoded point cloud data, comprising one or more processors configured to:
obtain, for a point of the point cloud, a sensor index (λₙ) associated with a sensor that captured the point, an azimuthal angle (ϕₙ) representing a capture angle of the sensor, each captured point being represented by a point in a 2D discrete angular plane in which the sensor index (λₙ) is a coordinate of a first axis of the 2D discrete angular plane and the azimuthal angle (ϕₙ) is a coordinate of a second axis of the 2D discrete angular plane;
obtain a list of ordered points of the point cloud by ordering points of the point cloud according to a lexicographic order based first on azimuthal angles (ϕₙ) and then on sensor indices (λₙ) or inversely, an order index being associated with each point of the point cloud according to a rank of the each point in the list of ordered points;
obtain a next point (Pₙₑₓₜ) following a current point (Pₙ) in the list of ordered points, and having an order index (o(Pₙₑₓₜ)) different of an order index (o(Pₙ)) of the current point (Pₙ), and obtaining a number (Ndupₙ) of duplicated points equals to a number of points following the current point (Pₙ) that have an order index equals to the order index (o(Pₙ)) of the current point (Pₙ);
encode, in the bitstream, the number (Ndupₙ) of duplicated points; and
obtain and encode, in the bitstream, an order index difference (Δoₙₑₓₜ) representing a difference between the order index (o(Pₙₑₓₜ)) of the next point (Pₙₑₓₜ) and the order index (o(Pₙ)) of the current point (Pₙ)).

10. An apparatus of decoding a point cloud captured by a set of sensors from a bitstream of encoded point cloud data, comprising one or more processors configured to perform the method of claim 3.

11-12. (canceled)

13. A non-transitory storage medium carrying instructions of program code for executing the method of claim 1.

14. (canceled)

15. A non-transitory storage medium carrying instructions of program code for executing the method of claim 3.

16. The method of claim 4, wherein each binary data is context-adaptive arithmetic decoded such that a context used to decode a binary data depends on a sensor index associated with the already decoded current point.

17. The method of claim 4, wherein decoding the number (Ndupₙ) of duplicated points further comprises decoding a residual obtained as a difference between the number (Ndupₙ) of duplicated points and the maximum bound.

18. The method of claim 17, wherein decoding the residual comprises:
decoding the residual by using an expGolomb code.

19. The method of claim 3, wherein the method further comprises
decoding, from the bitstream, a binary information (BPₙ) indicating whether duplicated points of the already decoded current point (Pₙ) have or not same three-dimensional coordinates.
